(19) United States
(12) Patent Application Publication
(10) Pub. No.: US 2006/0277101 A1
(43) Pub. Date: Dec. 7, 2006

(54) System and Method for Maintaining Distributor Loyalty

(75) Inventor: Arthur Bunn, Springfield, IL (US)

Correspondence Address: BARNES & THORNBURG LLP, P.O. BOX 2786, CHICAGO, IL, 60690-2786, US

(73) Assignee: BUNN-O-MATIC CORPORATION, Springfield, IL (US)

(21) Appl. No.: 11/419,449

(22) Filed: May 19, 2006

Related U.S. Application Data
(63) Continuation-in-part of application No. 10/522,639, filed on Jan. 26, 2005.
(60) Provisional application No. 60/400,829, filed on Aug. 2, 2002.

(51) Int. Cl. G06Q 30/00; G07G 1/00

(52) U.S. Cl. 705/14; 705/10

(57) ABSTRACT

A system, method, and computer software product for use by a manufacturer to offset a loss of one or more of the manufacturer's distributors caused by a displacing a distributor's sale when the manufacturer operates an e-commerce enabled web site that sells products directly to consumers. The distributor is compensated in response to be identified by the consumer as where the consumer would have bought the product if the product was not directly available from the manufacturer. The user's participation in selecting a distributor can be optional or mandatory. If optional, the user may be compensated for participating. The list of distributors presented to the user is based on equitable selection method so that one distributor is not favored over the others. The distributor may also be compensated without a selection by the consumer by being selected based on the consumer's geographic region or the selected product's availability at a local distributor.

### RELATED APPLICATIONS

This application is a Continuation-In-Part of application Ser. No. 10/522,639, filed Jan. 26, 2005 which is a U.S. Nationalization of PCT Application No. PCT/US2003/24446, filed Aug. 1, 2003, which claims priority to U.S. Provisional Patent Application 60/400,829 filed Aug. 2, 2002. The prior applications are expressly incorporated herein by reference in their entirety.

### BACKGROUND

This disclosure is generally directed to a system, method, and computer software product for use by a manufacturer to benefit the manufacturer's distributors when the manufacturer sells its products over the Internet directly to consumers.

Many manufacturers today maintain an Internet presence. Often this presence is limited to a static web site providing information about the manufacturer and specifications for the manufacturer's products. Consumers are increasingly visiting manufacturers' web sites in search of information about the manufacturer's products.

In the past, selling products on a web site was generally more expensive than maintaining a static web site. As the incremental cost of enabling web commerce over mere maintenance of a static web site has come down, many manufacturers have instituted shopping carts and other interfaces to allow consumers to purchase products directly from the manufacturer's web site. Consumers who traditionally visit the manufacturer's web site solely for informational purposes may buy products from the manufacturer when they arrive at the site and see that such direct purchasing is available.

The result of this change in the functionality of manufacturers' web sites may have a detrimental effect on the relationship between manufacturers and their distributors. Distributors have maintained an advantage over manufacturers based on the ability of the distributors to provide convenient access to manufacturer's products via their retail distribution networks. The Internet has eliminated that advantage because from a consumer's point of view, there is no added convenience in purchasing directly from a distributor or the distributor's web site compared to purchasing from the manufacturer's web site.

Manufacturers still need to utilize distributors to reach brick-and-mortar purchasers and to take full advantage of a maximum number of distribution channels. There is therefore a need for a manufacturer to maintain the loyalty of distributors while at the same time building its online presence. This need is fulfilled by the present disclosure which provides a system, method, and computer software product by which a manufacturer can provide a benefit to its distributors for sales which might be displaced when a consumer purchases from a manufacturer's web site directly.

### SUMMARY

Briefly, and in accordance with the foregoing, the present disclosure describes a method for use by a manufacturer to provide a benefit to one or more of the manufacturer's distributors when the manufacturer operates an e-commerce enabled web site that sells products directly to consumers. Also disclosed is a system and a software product for operating the method.

The method allows a user on the manufacturer's web site to select at least one product for purchase. At some point later in the purchase process, either before, during, or after checkout, the user may be presented with a list of distributors that also sell that product. The user actively or passively selects which of these distributors the user would have purchased the item from if the product was not available directly from the manufacturer. The selected distributor is credited with a benefit from the manufacturer.

Additional features will become apparent to those skilled in the art upon consideration of the following detailed description of drawings.

### BRIEF DESCRIPTION OF THE DRAWINGS

The detailed description particularly refers to the accompanying figures in which:

FIG. 1 is a diagrammatic view of an embodiment of a method in which a list of distributors selling a product is presented after a selection of the product on a manufacturer's web site;

FIG. 2 is a diagrammatic view of another embodiment of the method in which a consumer provides information about where the consumer plans to buy the product in lieu of completing an order;

FIG. 3 is diagrammatic overview of another embodiment of the method where a consumer choosing to continue their purchase at the manufacturer's web site may participate in a survey asking where they would have purchased the product but for availability at the manufacturing web site;

FIG. 4 is diagrammatic general overview of another embodiment of the system and method in which participation in the survey occurs after checkout has begun;

FIG. 5 is a diagrammatic view of steps involved with participating in the survey;

FIG. 6 is a diagrammatic view showing further detail of participation in the survey;

FIG. 7 is a diagrammatic view of steps used to generate a list of distributors to be shown to the consumer during the survey;

FIG. 8 is diagrammatic view of the various benefits which may be provided to a distributor when that distributor has been chosen by the consumer during the survey;

FIG. 9 is a simplified diagrammatic view of a system for operating the present method; and

FIG. 10 is a diagrammatic view of another embodiment of a method for benefiting distributors.

### DETAILED DESCRIPTION OF THE DRAWINGS

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

The present method and system can be used in association with a relationship such as between entities on a vertical distribution chain. In one example, at the top of such a distribution chain are traditional creators of goods and services, such creation including but not being limited to growing, forming, designing or assembling goods or providing, developing and delivering services. Other entities are found the distribution chain, often referred to as distributors. At the bottom of the distribution chain are the ultimate end users such as businesses or consumers. Varying models exist for the number of entities included in a vertical distribution chain. For example, a simple distribution chain has goods flowing from a manufacturer, to a distributor, and then to a consumer. Another vertical distribution chain example has goods flowing directly from the manufacturer to the consumer. Yet another example is having goods flow from a manufacturer to a regional distributor, to a local distributor, or store and then to the consumer.

The present disclosure broadly covers all types of vertical distribution chains. A “first entity” is an entity in the vertical distribution chain above a “second entity” which is an entity lower in the chain. The present method can therefore be valuable to distributors which might lose sales to manufacturers, or distributors losing sales to other distributors above them in the distribution chain. For convenience, but without limitation the disclosure refers to the first entity as a “manufacturer” and a second entity as a “distributor.” Similarly, the end user is referred to as a “consumer”, “customer”, or a “user.” The first entity may also be an e-commerce web site operator who works with one or more distributors to distribute goods and services.

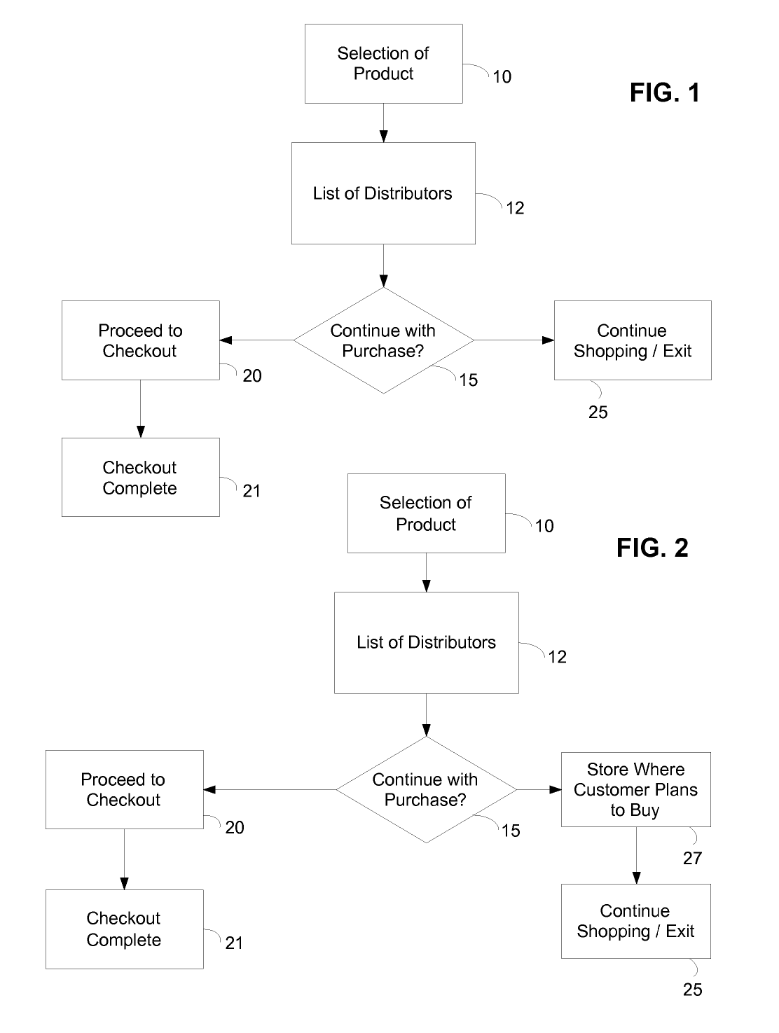

With reference to the figures, FIG. 1 shows an example of one embodiment of the method including the general steps by which a consumer visiting a manufacturer's web site takes to participate in selecting from which distributor the consumer would have purchased the product. For simplicity, but without limitation the participation is referred to as a “survey.” A consumer visits the manufacturer's web site and finds that the consumer can purchase products directly from the manufacturer. The interface can be any type of e-commerce enabled web site which, for example, may be any shopping basket interface that allows a user to browse goods for sale, select goods for purchase, and then pay for the goods electronically. Although “products” or “goods” are commonly purchased using such interfaces, the present disclosure contemplates that services may be purchased as well.

In a first step 10, the consumer may select a product to put in their shopping cart and in a second step 12 is immediately presented with a list of distributors that also sell the product. In a next step 15, the consumer is presented with a choice of whether or not the consumer wishes to continue the purchase in light of the availability of the product at the distributor or at the distributor's stores. If the consumer chooses not to continue with the purchase, the consumer is returned to the general web site or otherwise exits the purchasing process 25. If the consumer chooses to continue with the purchase, the next step 20 is to proceed to checkout where order information such as payment and shipping information is gathered to complete the order. At this point, checkout is complete 21.

Throughout the disclosure, the distributor who may be losing a sale, referred to hereinafter as experiencing a “displaced sale,” will benefit from or otherwise will receive some form of compensation for the displaced sale. In this embodiment, a given distributor is receiving a benefit or value from the system and method because the distributor's name is displayed on the list of stores. This alerts the consumer that the manufacturer's products are sold at the distributor's store which in turn may result in the consumer purchasing the product from that store in the future or purchasing related products from that store. In this manner, the consumer's mental connection between the manufacturer's product and the distributor's store is reinforced. Such reinforcement is advantageous to the distributor from a marketing perspective.

In FIG. 2, an additional step is added to the previous embodiment between the choice to continue the purchase 15 and exiting the shopping cart 25. In this embodiment of the method, in an additional step 27, after the consumer has indicated that they wish to terminate their order, they are asked at which replacement store they plan to buy the product. The consumer is prompted with the list of distributors which was previously presented after they selected the product as well as with an “other” choice where the consumer can enter a distributor not included in that list. The consumer selects among the choices after which they may continue shopping or exit the purchasing interface. The replacement store 27 is noted. In this manner, the manufacturer is made aware of which distributors are continuing to make sales even though the manufacturer has established an online store.

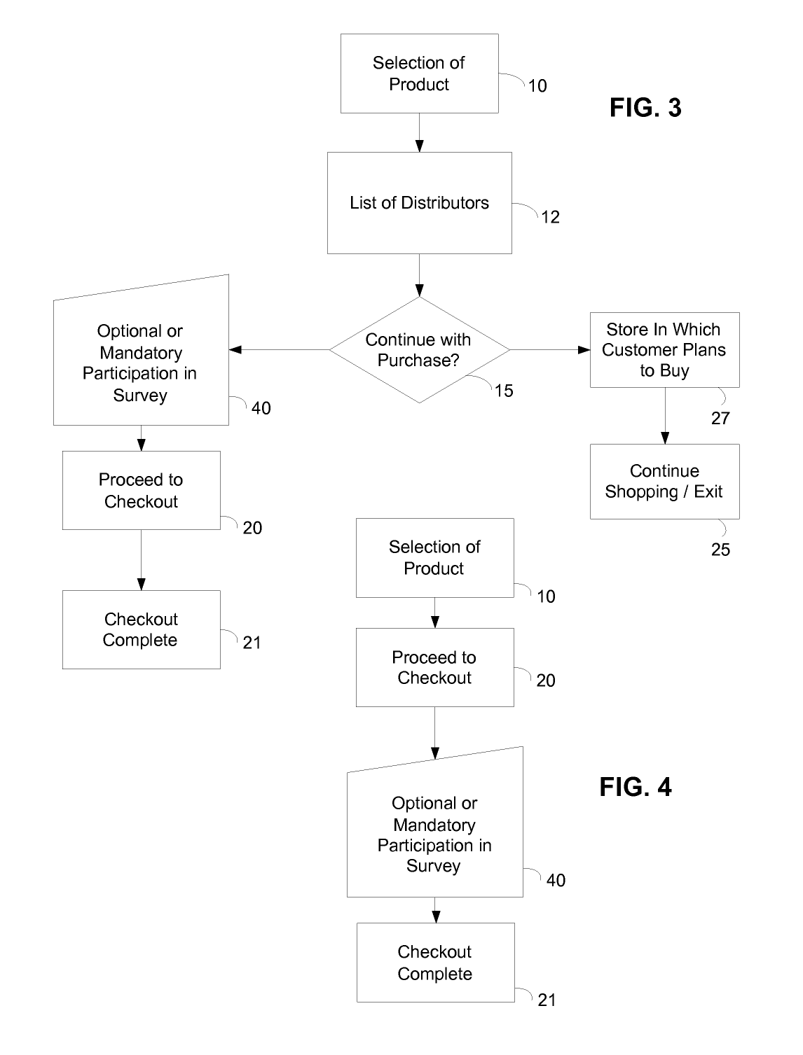

FIG. 3 shows another embodiment which adds another track by which information about the purchase is collected. As in the previous embodiments, in one step, for example, a first step 10, the consumer selects a product, in a second step 12 is presented with a list of stores also selling the product, and is asked to choose whether the consumer wishes to continue the purchase in step 15. Here, if the consumer chooses to continue, before the consumer can proceed to a checkout step 20, the consumer may take the step 40 of participating in a survey asking where they would have purchased the product if the product was not available from the manufacturer's web site. In participating in the survey, the consumer informs the manufacturer about which distributor is experiencing the displaced sale. The distributor may then receive a benefit for this displaced sale. The benefit to the distributor, such as some for of credit or compensation bolsters the relationship between the distributor and the manufacturer even though some of the distributor's sales may be displaced.

FIG. 4 shows another embodiment where the participation step 40 occurs after the checkout complete step 21. This order may be useful, if, for example the manufacturer desires the consumer to be farther along in the purchasing process before being confronted with the survey. In this manner, the current method can prompt the user either before the user can complete the purchase or after the user completes the purchase to select a displaced distributor.

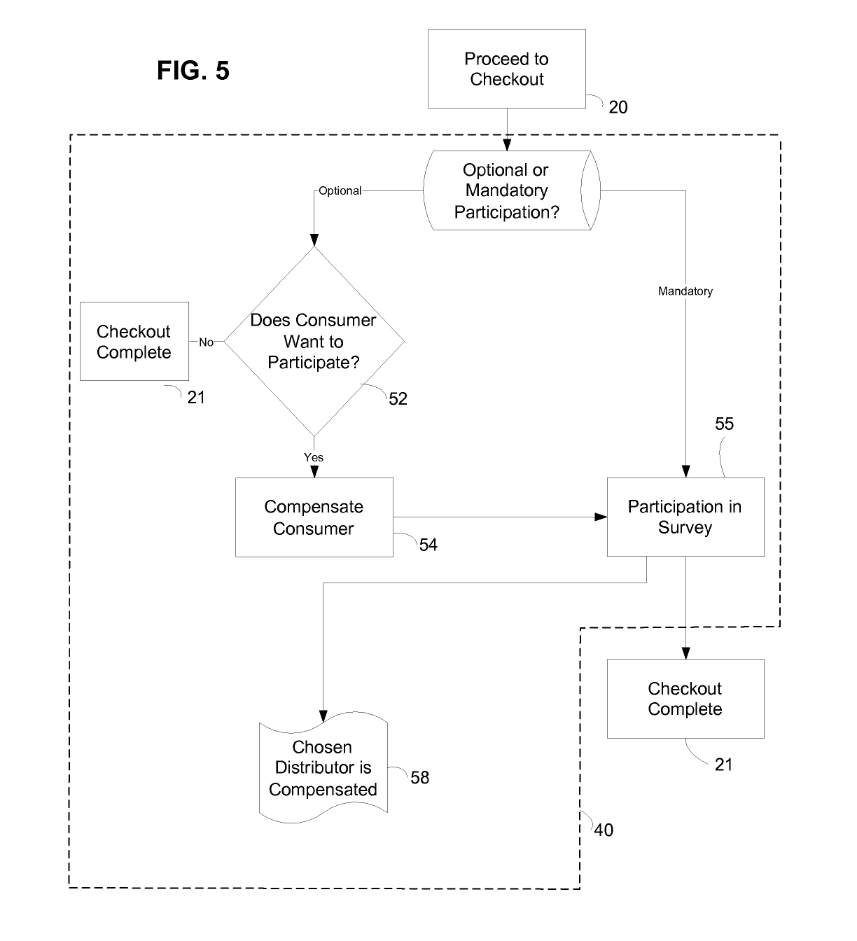

FIG. 5 provides further detail on the participation in the survey step 40. Participation in the survey may be optional or mandatory. A manufacturer may not want to burden consumers visiting their site with participating in the survey in which case the manufacturer may choose to make the survey optional. To do so, a question 52 such as “Would you like to participate in a survey?” may be posed. To persuade the consumer to participate, the manufacturer may offer a benefit, such as some form of compensation 54 to the consumer. Examples of such consumer compensation may include but are not limited to a coupon, a price reduction or discount, a rebate, access to special offers, free goods or services, entry into contests, prizes, a credit for future purchases, a point accumulation incentive program or cash. After being compensated, the consumer participates in the survey 55. If the consumer chooses not participate, the purchasing process continues until checkout is completed in checkout step 21.

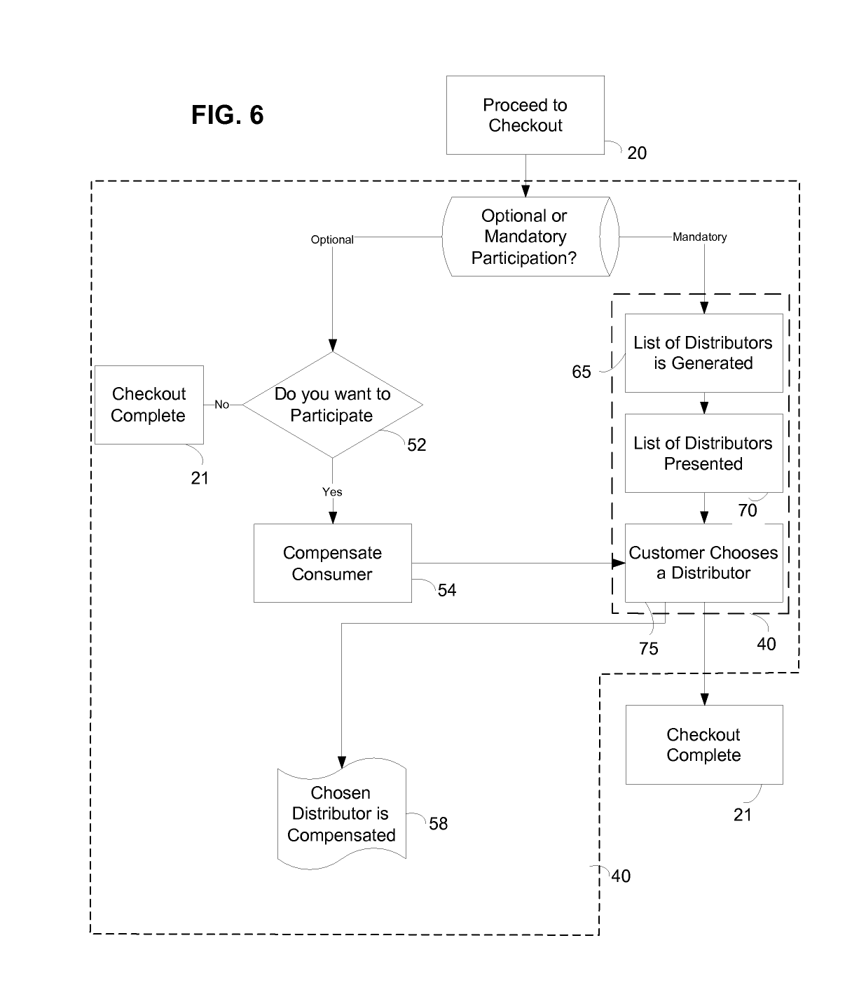

FIG. 6 provides additional details of the participation in the survey step 55. First, a list of distributors is generated in step 65. These stores are presented to the consumer who is asked to select at which store the consumer would have purchased the product if the consumer could not purchase from the manufacturer's website directly. It should be understood that the manufacturer may have more distributors then can be conveniently displayed during the checkout process. Alternatively, the manufacturer may not wish to display certain distributors more often or at more favorable positions on the list, such as on the top of the list. Also, the manufacturer may not want to distance one distributor by unfairly favoring other distributors. For reasons such as these, the manufacturer may want to display the distributors on the distributor list according to a selection method which may be more equitable. An equitable selection method may take into account fairness to distributors, the relationship to the consumer and the distributors, the relationship between the manufacturer and the distributor as well as, other considerations and combinations of these considerations.

Using an equitable selection method may be useful in situations in which less than all distributors can be displayed. A user's time is valuable and users do not like to scroll through long lists while trying to complete a product purchase. For this reason, a limited time-convenient number of distributors is displayed. Any time-convenient number of distributors is suitable, such as for example, three or five distributors.

In one embodiment of an equitable selection method, the list of distributors may be refined to only display distributors within a geographically-related or politically related proximity to the consumer. The distance within the geographically-convenient area can differ depending on the types of goods. For example, a user may be willing to travel farther for a hard to find luxury good, but not a commonly available consumer good. Therefore such related areas may include but are not limited to being within the same or a range of zip code, city, county, or region. The list may also be refined to include stores in an area specified by the consumer, for example an area within five miles from a specified address or landmark. The consumer chooses a distributor in step 75 from the list 70 and continues the purchasing process until checkout is completed in the checkout step 21.

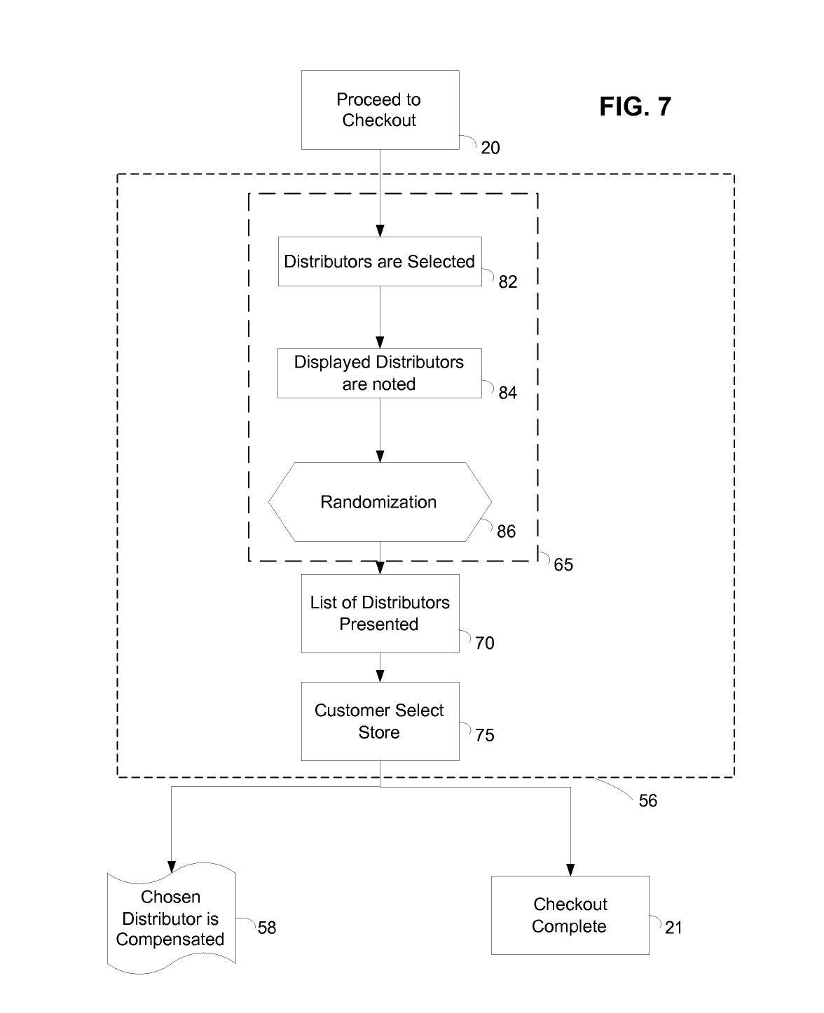

FIG. 7 provides additional detail of how the list of distributors in the list of distributors step 65 is generated. Which distributors will be included in this the distributor list can be left to the manufacturer's discretion. For example, the manufacturer might use a criteria such as a distributor with a long-running mutually beneficial relationship with the manufacturer that faces considerable financial harm due to lost sales might be included. On the other hand, a new untested distributor whose loyalty is not vital to the manufacturer might be less likely to be included. Because the manufacturer will be providing benefits to selected distributors at the manufacturer's expense, the manufacturer will ultimately have to make a business decision as to which distributors will be included in the database 80.

Distributors can also agree to provide incentives to the manufacturer in exchange for being included in distributor list. This incentive can take any form such as providing additional marketing efforts, additional or more favorable product or advertising placements for the manufacturer's goods and services, or specific advertising placements such as signs or store aisle end caps.

Step 82 involves the selecting which distributor would be included in the list of distributors to be presented to the current consumer. The selection step 82 is made so that each distributor appears to consumers at a frequency commensurate with an equitable selection method chosen by the manufacturer. The equitable selection method may be to display all stores at an equal frequency. Another equitable selection method may be to display distributors at a frequency proportional to the value of the products purchased by the distributor from the manufacturer for some prior time period, such as the previous year, month, or quarter. Yet another equitable selection method may be to display all stores randomly. The random selection method can help the manufacturer to collect information about which stores are most popular to consumers. Another selection method is displaying stores on a cyclical basis so each store is displayed sequentially and then the list is repeated to display each distributor again.

After the selection step 82, the displays stores are noted in a step 84 to reflect that the distributors have been chosen so that when the next consumer participates, the determination of whether that distributor is displayed in the survey follows the manufacturer's strategy.

Also, the list may randomized in step 86 in order to make the list ordering fair. For example, generally consumers have been found to select the top choice in a list of choices to save time when presented with an online survey having marginal importance to them. Randomization 86 of survey items partially cancels the effects of this tendency.

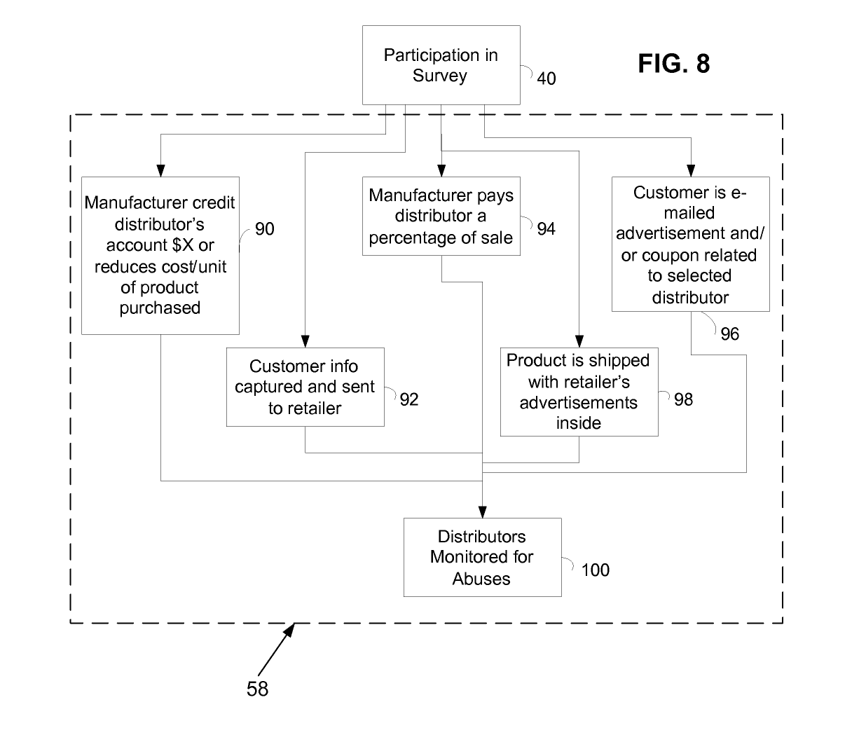

Referring now to FIG. 8, after the consumer has participated in the survey, the distributor receives a benefit or a credit, such as some form of compensation, in a compensation step 58 for the displaced sale. The form of compensation may include but is not limited to many different benefits. For example, the manufacturer may credit the distributor's account 90 by a certain dollar amount each time a consumer selects that distributor's store or may reduce the cost per unit to the distributor of the purchased product. Another form of compensation may be supplying the distributor with the customer information 92 captured during the sale to the distributor. Customer lists are valuable in Internet commerce and having a consumer who has already shown an interest in the distributor by selecting the distributor from the presented list may be of value to the distributor. Another form of compensation may be to pay the distributor a percentage of each sale 94. Yet another form of compensation would be to ship the distributor's coupons, rebates, advertisements or other distributor promotional materials 98 inside the packaging of the purchased product. Yet another form of compensation would be to send electronic copies of such distributor promotional materials to the purchasing consumer via email 96.

It should be noted that the current method contemplates having a class or pool of distributors be compensated when one member of that class or pool is selected. This can be useful when the displaced sale affects a whole industry or group of distributors or when a distributor has multiple locations, only one of which can be selected by the user. It is also contemplated that a user can select more than one distributor or rank two or more distributors during the survey. Such a pool may then receive a benefit based on some criteria such as equal division, proration or other method of dividing the pool benefit fund.

Whichever form of compensation is provided to the distributor, the compensation to each distributor is noted. An additional step 100 is to monitor for misuse of the system by distributors. The manufacturer may deal with such misuse as needed by taking corrective action such as removing a distributor from the distributor list, reducing compensation to a distributor, or by otherwise changing or severing its relationship with the misusing distributor. An example of a misuse is having sham consumers make purchases and repeatedly select the misusing distributor in the survey shown during the purchases.

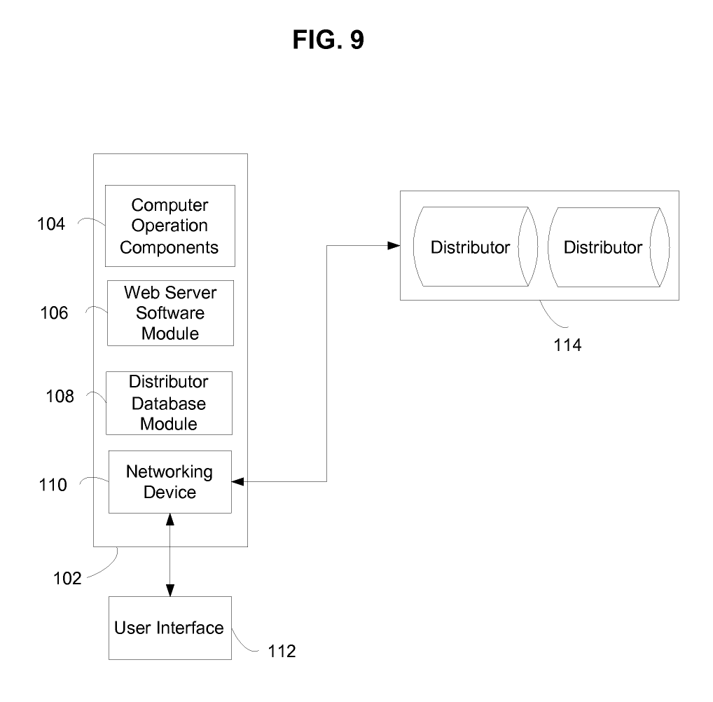

FIG. 9 shows a simplified diagrammatic view of a host system 102 for operating the current method. The system 102 includes computer operation components 104 that are generally found in industry standard general purpose computers and/or server systems, such as a processor, motherboard, and storage device. The storage device may be a hard drive, a tape drives or the like, or combinations of multiple hard drives or tape drives for security and system failure redundancy purposes such as RAID arrays. The storage device has software loaded thereon for operating the computer operation components 104 as well as storing the web server software module 106. The term “software module” referenced in this disclosure is meant to broadly cover various types of software code including but not limited to routines, functions, objects, libraries, classes, members, packages, procedures, methods, or lines of code together performing similar functionality to these types of coding used to enable a processor to perform tasks specified by the module.

The web server software module 106 may be written in any web server authoring software language. The web server software module 106 allows access by users via a well known user interface 112, such as a browser interface, available on a user's workstation or computer. The system 102 also includes a distributor database module 108, stored on the storage device of the system 102, for managing information related to generating the distributor list and noting which distributors have been selected and are to be compensated. The distributor database module 108 may be written in any software programming language or be created using a customized commercially available database product such as Microsoft SQL Server.

The system 102 also includes a networking device 110 such as an Ethernet network card for connection to the user interface 112 and optionally to one or more distributors' systems 114. In such an embodiment, distributors can monitor user selections and/or their compensation flow from information provided by the system.

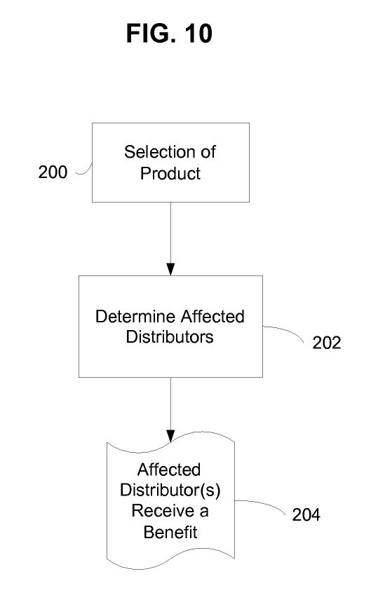

FIG. 10 shows another embodiment of the present method. The embodiment illustrated in FIG. 10 shows providing a benefit to an affected distributor without the need for a consumer's input or selection about a particular distributor. In this embodiment, the affected distributor is identified based on other criteria about the product selected and/or information about the consumer's location. As shown in step 200, a consumer identifies a particular product for purchase. The system then identifies a distributor that might normally sell the product to the consumer based on the relevant geographic or supply line region where the consumer is located or otherwise receives goods and/or services (step 202). The distributor identifying information may include but is not limited to the consumer's city, state, zip code, county, country, region, or address. The distributor identifying information may be based on, but is not limited to, information may be collected at the time of ordering, retrieved from cookies on the consumer's system, or determined by the IP address of the consumer. In a step 204, the affected distributor or distributors may receive some benefit. The benefit may include any of the benefits described above, and may also include the order being shifted to the affected distributor for fulfillment. This method can also be used to shift the order in the case that the manufacturer or its usual distributors are out of stock for the selected product or service. In this manner, even without the consumer identifying a particular distributor the consumer would have used but for the manufacturer's web site, the affected distributor can still realize some benefit including an incremental increase in sales.

The current methods can also be embodied in an computer software product. The computer software product includes machine executable code written for performing the steps and functionality described above, the machine executable code being stored on a computer-readable medium such as CD-ROM or floppy disc. The computer software product could also be the machine executable code packaged in one or more files for downloading and subsequent installation on a computer.

While embodiments of the disclosure are shown and described, it is envisioned that those skilled in the art may devise various modifications and equivalents without departing from the spirit and scope of the disclosure as recited in the following claims.

What is claimed is:

1. A method for use by a first entity to benefit a second entity in the operation of an e-commerce enabled web site, the method comprising the steps of:
allowing a user of the e-commerce enabled web site to select at least one of a product and a service for purchase;
determining a second entity based on information about the user; and
providing a benefit to the second entity.

2. The method of claim 1, wherein providing a benefit to the second entity is shifting the sale of the at least one product and service selected by the user to the second entity.

3. The method of claim 1, wherein providing a benefit to the second entity is paying the second entity a percentage of a purchase price of the at least one product or service for purchase.

4. The method of claim 1, wherein providing a benefit to the second entity is shipping the at least one product or service for purchase along with advertising about the second entity.

5. The method of claim 1, wherein providing a benefit to the second entity is sending the user a coupon for the product or service sold by the second entity.

6. The method of claim 1, wherein providing a benefit to the second entity is sending the second entity information about the user.

7. The method of claim 1, further comprising the information about the user being geographic information about a location of the user.

8. The method of claim 7, further comprising the geographic information being one or more of a city, state, zip code, county, country, region, and an address for the user.

9. The method of claim 7, further comprising the geographic information being an internet protocol address of a system used by the user to access the e-commerce enabled web site.

10. The method of claim 1, further comprising the information about the user comprising an availability of the at least one product and service for purchase in a geographic region of the user.

11. The method of claim 10, further comprising the geographic information about the user being one or more of a city, state, zip code, county, country, region, and an address for the user.

12. The method of claim 10, further comprising the geographic information about the user being an internet protocol address of a system used by the user to access the e-commerce enabled web site.

13. The method of claim 1, further comprising a step of monitoring the benefit to the second entity for abuses.

14. The method of claim 13, wherein in response to finding an abuse by a second entity, taking a corrective action.

15. The method of claim 14, wherein the corrective action is removing a second entity committing an abuse from the list of second entities that can receive a benefit.

16. The method of claim 15, wherein the corrective action is reducing the benefit to a second entity committing an abuse.

17. The method of claim 1, further comprising the first entity being a manufacturer, and the second entity being a distributor of at least one good and service offered by the manufacturer.

18. The method of claim 1, further comprising the first entity being an e-commerce web site operator, and the second entity being a distributor of one of goods and services.

19. The method of claim 1, further comprising the first entity being a distributor and the second entity being a distributor, the first distributor being above the second distributor in a supply chain.

20. The method of claim 1, further comprising the first entity being a manufacturer and the second entity being a retailer.
